(19) United States
(12) Patent Application Publication
(10) Pub. No.: US 2019/0203802 A1
(43) Pub. Date: Jul. 4, 2019

(54) FLYWHEEL ENERGY STORAGE SYSTEM

(71) Applicant: KAZAK TECHNOLOGIES, INC., Georgetown, ME (US)

(72) Inventor: Michael McAleenan, Georgetown, ME (US)

(21) Appl. No.: 16/237,557

(22) Filed: Dec. 31, 2018

Related U.S. Application Data
(60) Provisional application No. 62/612,626, filed on Dec. 31, 2017.

(51) Int. Cl. F16F 15/305; F16C 32/04; H02K 7/02; H02K 7/09

(52) U.S. Cl. CPC F16F 15/305; F16C 32/0459; F16C 2361/55; H02K 7/025; H02K 7/09; F16C 32/0491

(57) ABSTRACT

Flywheel system properties are enhanced with rim designs that control stress at operational rotational velocities. The tensile strength of fiber-resin composites can be aligned with radial forces to improve radial stress loading. Loops with composite casings can be arranged around the flywheel circumference with a majority of the fibers being aligned in the radial direction. The loops can enclose masses that contribute to energy storage in the flywheel system. The masses subjected to radial forces can provide compressive force to the loops to contribute to maintaining loop composite integrity. With the alignment of fibers in radial directions, higher loading permits increase in rotational velocities, which can significantly add to the amount of energy stored or produced with the flywheel.

### CROSS-REFERENCE TO RELATED APPLICATIONS

This application claims the benefit of U.S. Provisional Patent Application Ser. No. 62/612,626, filed Dec. 31, 2017, the entire contents of which are hereby incorporated herein by reference.

### STATEMENT REGARDING FEDERALLY SPONSORED RESEARCH OR DEVELOPMENT

This invention was made with government support under Contract No.: N68335-17C-0310 awarded by the United States Navy. The government has certain rights in the invention.

### BACKGROUND

Current megawatt flywheel systems use commercial rims composed of either carbon fiber/epoxy or carbon fiber & glass fiber/epoxy materials. Limiting the rotational velocity of commercial rims is the radial force acting on the comparatively weak matrix (epoxy) properties. Composite rims currently fail gracefully as a result of delamination, typically due to the radial force acting on the cross sectional geometry/mass of the rotating rim.

### SUMMARY

Flywheel system properties are enhanced with rim designs that control stress at operational rotational velocities. The tensile strength of fiber-resin composites can be aligned with radial forces to improve radial stress loading. Loops with composite casings can be arranged around the flywheel circumference with a majority of the fibers being aligned in the radial direction. The loops can enclose masses that contribute to energy storage in the flywheel system. The masses subjected to radial forces can provide compressive force to the loops to contribute to maintaining loop composite integrity. With the alignment of fibers in radial directions, higher loading permits increase rotational velocities, which can significantly add to the amount of energy stored or produced with the flywheel.

According to some examples, a flywheel for a flywheel energy storage system includes a hub configured to rotate about a longitudinal axis, a fiber-resin composite material coupled to an outer side of the hub, where at least some of the fibers in the composite material are radially aligned with respect to the longitudinal axis. The flywheel may include a disc section composed of the fiber-resin composite material coupled to the hub. The flywheel may include a loop composed of the fiber-resin composite material coupled to the hub. A mass may be housed within the loop such that the mass can apply compressive force to the loop when a radial force is applied to the mass. The mass composition may include aluminum or steel, for example. A percentage of fibers aligned in the radial direction may be in an inclusive range of from about 25% to about 90%. Four or more loops may be arranged symmetrically around the hub.

The hub and a fiber-resin composite material may be configured to withstand a rotational velocity in an inclusive range of from about 15,000 rpm to about 50,000 rpm. The rim diameter may be in an inclusive range of from about 45.7 cm (18 in) to about 203 cm (80 in). The flywheel may be configured to obtain a kinetic energy in an inclusive range of from about 10 MJ to about 3000 MJ. The fiber-resin composite material may be releasably coupled to the outer side of the hub, such that the flywheel is modular in construction.

A method for constructing a flywheel for a flywheel energy storage system may include coupling a fiber-resin composite material to an outer side of a hub configured to rotate about a longitudinal axis, and aligning at least some of the fibers in the composite material in a radial direction with respect to the longitudinal axis. The method may include arranging the fiber-resin composite material in a loop. The method may include disposing a mass within the loop such that the mass can apply compressive force to the loop when a radial force is applied to the mass. The method may include disposing four or more loops symmetrically around the hub. The method may include fastening the loop to the hub with one or more of a bolt, a nut, a threaded opening in the loop, or a rod and shear pin or shear web. The method may include implementing a rim diameter in an inclusive range of from about 76.2 cm (30 in) to about 203 cm (80 in).

A method for operating a flywheel for a flywheel energy storage system may include operating the flywheel at a rotational velocity in an inclusive range of from greater than 16,000 rpm to about 50,000 rpm. The method may include operating the flywheel to obtain a kinetic energy in an inclusive range of from about 200 MJ to about 3000 MJ.

In the flywheel system, the mass of the rim can be utilized to alter rim cross sectional geometry at design speed. Elliptical cross sectional shaped rims utilize bending stresses to mitigate radial stress. In the present disclosure, rim mass is a design variable, that permits rim rotational velocity improvement or optimization by increasing or decreasing the rim's mass moment of inertia. This modification was not used in any previous commercially designed composite flywheel rim.

Adding nano fillers to the resins offer a limited increase in matrix tensile strength. The fiber tensile strength of 711 ksi is used for the tensile strength model, which far exceeds current nano/matrix solutions.

Decades worth of test data are used to analyze and to validate the disclosed new rim designs. The test data is derived from commercial rims with a carbon fiber/glass fiber/epoxy matrix running in the hoop direction or around the perimeter of the rim. The rim is approximately 7″ thick and is rated for rotational velocity of 16,000 rpm. This type of composite rim has been state of the art for 30 years. At 16 k rpm the rim uses approximately 10% of the tensile strength of the carbon fiber. This lower utilization has lead to rim failure over time due to the radial force acting on the thru thickness mass of the carbon/glass/epoxy rim, e.g., acting in the radial direction. The rim's reaction to this force is the comparatively weak epoxy matrix tensile strength. Rim radial stress has controlled lightweight composite flywheel rim design for decades.

The rim designs discussed herein control the application of radial stress, in part by separating the rim and mass components. The interaction between rim, separate mass and the radial force acting on that separate mass permits design modifications and improvements that are unavailable in prior designs. In some examples, the separate mass reacts to the radial force at a designed rotational velocity, such that the separate mass applies a compressive force to the laminate. The separate mass compressive force counteracts the through laminate thickness radial tensile force that causes current state of the art commercial composite rims to delaminate. The separate mass compressive force is dependent on material density, radial position and rotational velocity, which permits radial stress to be controlled by design.

Flywheel ancillary equipment parasitic losses are reduced to improve Flywheel Energy System (FES) efficiency. The design of the rotating flywheel can contribute to ancillary equipment design and efficiency. One approach to improve FES efficiency is to significantly reduce the weight of the flywheel rim. Another approach is to increase rotational velocity of the rim. Some benefits of these approaches, individually or in combination are discussed below.

A lightweight rim can reduce the energy used by homopolar magnetic bearing structure, which can contribute to lowering magnetic bearing parasitic losses. A lighter rim can contribute to reducing parasitic energy losses in motor/generator configurations.

Significantly increasing rim rotational velocity can have a direct effect on reducing motor/generator specifications or energy usage. Such reductions can lead to lower motor/generator parasitic losses. Significantly increasing rotational velocity has the added benefit that each FES unit stores more energy. With such a benefit, fewer FES units can be used for a given storage capacity, leading to reduced costs. In addition, a reduction in the number of units can have a beneficial effect on space usage, which can be of significant value in situations where space is constrained, such as onboard naval ships with tight space restrictions.

Commercial megawatt flywheel systems may have a rotational velocity of about 16,000 rpm. If a flywheel were to operate at twice the rotational velocity, e.g., 32,000 rpm, four times the energy storage may be obtained. Current megawatt flywheel commercial rims use either carbon fiber/epoxy or carbon fiber & glass fiber/epoxy materials. Limiting the rotational velocity of commercial rims is the radial force acting on the comparatively weak matrix (epoxy) properties. Composite rims currently fail gracefully as a result of delamination, this is due to the radial force acting on the cross sectional geometry/mass of the rotating rim. Current BP commercial megawatt flywheel systems have a specified or maximum rotational velocity is 16,000 rpm.

One design challenge to increasing rotational velocity to reduce ancillary equipment losses is to reduce radial stress. One factor that can practically constrain rotational velocity of flywheel systems is radial stress. In accordance with the present disclosure a flywheel design is provided that manages radial stress among other operating factors. A composite carbon fiber/epoxy innovative rim design is provided that permits rotational velocities of 32,000 rpm, which provides 4× energy stowage and kinetic energy of 20,565,537,339 in-lbf.

The disclosed design obtains carbon fiber tensile stress of 600,000 psi, and a radial stress below that of permitted commercial rim radial stress of 5900 psi. An ANSYS finite element software analysis on commercial carbon/epoxy rim models was used to validate the design against extensive commercial rim material test data. The resulting design demonstrates the ability to control composite rim radial stress by design.

The novel rim design is readily scalable. For example, a 32,000 rpm composite rim design is presented with a diameter is 40″. The disclosed designs can be used in a proposed 26″ and commercial 32″ rim system. The smaller diameters will experience reduced radial and hoop stresses at 32,000 rpm than the 40″ design. Taking advantage of carbon fiber tensile properties, the novel design permits these size rims to spin at higher rotational velocities.

The increased rim rotational velocity reduces FES ancillary equipment energy losses and hardware costs. The rim cross sectional design takes advantage of low cost extrusion and pultrusion fabrication processes.

Current commercial composite rims fail as a result of thru thickness intralaminate strain due to the rim's radial force acting on the laminate (thru thickness). As rotational velocity increases the radial force increases. Reacting through thickness radial force in commercial rims is the comparatively weak epoxy matrix (resin). The composite rim failure is due to the epoxy matrix, which has a lower tensile strength than the fibers, being debonded from the fiber causing a delamination. A delamination changes rim balance causing vibration. Detection of vibration causes the FES to shut down. Previous flywheel implementations have been limited in composite rim rotational velocity due to this factor.

Reducing/controlling composite rim radial stress is important to increase the energy-to-mass ratio and permit increased rotational velocity. Increased rotational velocity significantly increases kinetic energy, because kinetic energy increases as the square of the rotation speed (ω) versus a linear increase with mass. As rotational velocity increases so does the centrifugal force:

Centrifugal (Radial) Force: Fᵣ=m*ω²*r

Thus, while dense material (steel/aluminum) can store more energy, it is also subject to higher centrifugal force and thus fails at lower rotation speeds than low density material. Therefore, tensile strength may be a more important design consideration than density of material, which is one reason commercial rims use low density, high strength carbon & glass fiber/epoxy laminates.

The amount of energy storage per FES unit can be increased by increasing angular velocity (ω) for a constant radius (r). The two components of flywheel design that principally determine the total energy stored (Ek) for a given mass are radius (r) and rotational speed (ω). Ek can be expressed by: Ek=0.5 m_{c}r² ω², where m_{c} is total mass.

One rim energy benchmark equation is kinetic energy (KE): 0.5*Iₘ (spinaxis)*ω² (in-lbf), where Iₘ=mass moment of inertia of the rim about its spin axis: Iₘ=I+mr². A benefit of the new rim designs discussed herein is the ability to utilize rim mass as a design variable. If rim mass is doubled and rim geometry/rotational velocity are held constant, then Iₘ is doubled. Doubling Iₘ has the benefit of doubling the rim's KE.

One approach to significantly improve FES efficiency is to significantly reduce the weight and increase rotational velocity of the rim. Such changes can also reduce ancillary equipment parasitic losses. A lightweight rim implies less energy usage by homopolar magnetic bearing structure, which offers a significant opportunity to lower magnetic bearing parasitic losses. A lightweight rim also offers an opportunity to reduce motor/generator parasitic losses. Significantly increasing rim rotational velocity directly reduces motor/generator specifications, which therefore offers a significant opportunity to lower motor/generator parasitic losses. Significantly increasing rotational velocity increases stored energy, which reduces vacuum gap pumps % energy use. Significantly increasing rotational velocity has the added benefit that each FES unit stores more energy and therefore less units, i.e.: lower cost, may be used for a given storage capacity. In addition, fewer units have less impact on very tight space restrictions onboard vessels.

The flywheel rim designs may use the radial force acting on a mass to apply a compressive force to a composite laminate to reduce or minimize the through thickness laminate radial stress. In the absence of such a mass, the rim rotational velocity can be limited, such as to about 16,000 rpm. An annular ring design uses radial and spiral oriented fibers to counteract radial rim growth, thus reducing or minimizing thru thickness laminate radial stress of fibers running in the hoop direction.

If motor/generator rotational velocity is limited, loop rim geometry can expand the radius and increase filler mass. The new rim designs permit increased loading on the rim material for a given motor/generator speed, which can increase stored energy. Loop rim kinetic energy can be increased or designed to meet Navy requirements given a radius and/or rotational velocity specification.

The annular rim design, rather than utilizing mass to apply a compressive force to react rim radial stress, uses fiber orientation to restrict rim radial growth to reduce hoop aligned fiber radial stress. There are also a variety of geometrical options which can be employed to reduce both radial and hoop stress.

An example of costs savings provided by the new designs discussed herein is seen in a 20 MW flywheel farm that was funded by DOE at a cost of approximately $55 million. Twenty FES units were installed, which would be equivalent to four units capable of 6 MW/unit according to designs discussed herein. Such four units would cost approximately $11 million, resulting in a $44 million dollar savings.

### BRIEF DESCRIPTION OF THE SEVERAL VIEWS OF THE DRAWINGS

The disclosure is described in greater detail below, with reference to the accompanying drawings, in which:

FIG. 1 is a partially cut away top view of a flywheel system;

FIG. 2 is several partial cross-sectional finite element analysis (FEA) diagrams of radial displacement and radial stress for the flywheel system of FIG. 1 running at 16,000 rpm;

FIG. 3 is several partial cross-sectional FEA diagrams of hoop stress, axial displacement and axial stress for the flywheel system of FIG. 1;

FIG. 4 is a cross-sectional side view of an example flywheel design;

FIG. 5 is an isometric view of a flywheel hub from the example of FIG. 4;

FIG. 6 is a cut away isometric view of a portion of an example flywheel design showing attachment features;

FIG. 7 is a partial cross-sectional FEA diagram of radial stress for several lobes of the flywheel design of FIG. 4, normalized to 17237 kPa (2500 psi);

FIG. 8 is a partial cross-sectional FEA diagram of hoop stress for several lobes of the flywheel design of FIG. 4, normalized to 4137 MPa (600 ksi);

FIG. 9 is a partial cross-sectional side view of several lobes of a 10 loop flywheel design;

FIG. 10 is a partial cross-sectional side view of a flywheel rim with rim perimeter loops and mass layers;

FIG. 11 is a partial cross-sectional side view of several lobes of a 12 loop flywheel design;

FIG. 12 is a partial cross-sectional side view of several lobes of a 12 loop flywheel design;

FIG. 13 is a partial cross-sectional side view of several lobes of an 8 loop annular rim design with fiber orientation in the radial direction;

FIG. 14 is an isometric view of an annular rim design with a number of annular rims;

FIG. 15 is a partial cross-sectional side view of several lobes of an 12 loop annular rim design with fiber orientation in the radial direction;

FIG. 16 is an isometric view of a 10 lobe rim design with a hub band;

FIG. 17 is an isometric view of an 8 lobe flywheel design with a perimeter hub band;

FIG. 18 is an isometric view of an 8 lobe flywheel design with four quarter sections and a hub band; and

FIG. 19 is an isometric view of an 8 lobe flywheel rim that utilizes end hubs.

### DETAILED DESCRIPTION

New flywheel rim designs are presented and discussed herein. The rims may be operated in an inclusive range of from about 15,000 rpm to about 50,000 rpm. The rim diameter may be in an inclusive range of from about 45.7 cm (18 in) to about 203 cm (80 in). The flywheel configurations may be able to obtain a kinetic energy an inclusive range of from about 10 MJ to about 3000 MJ.

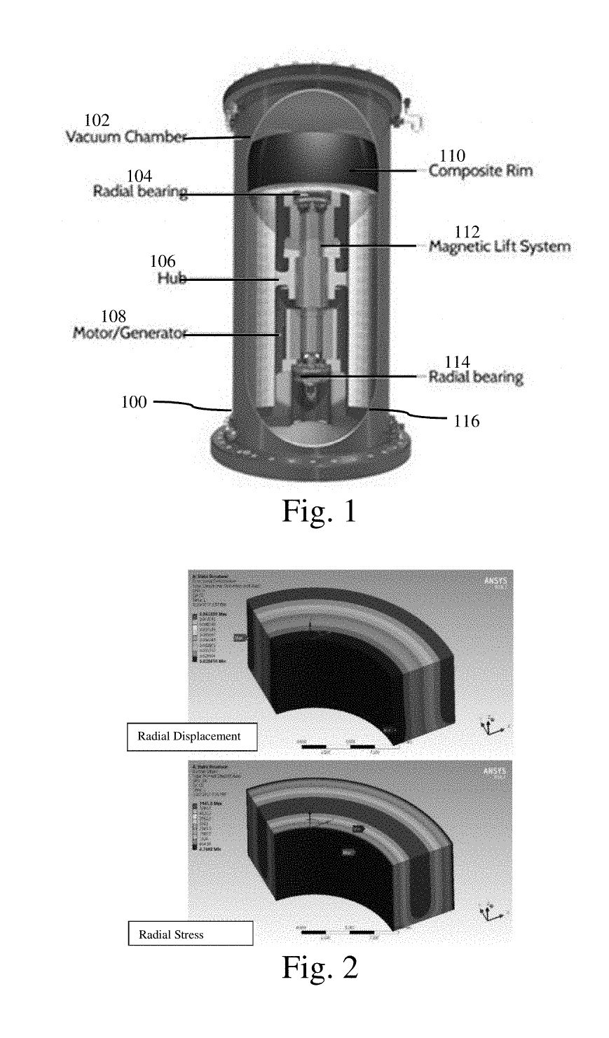

FIG. 1 is a partially cut away top view of a flywheel system 100. System 100 includes a casing 116 that houses the flywheel within a vacuum chamber 102. The flywheel has a carbon/epoxy composite rim 110 that is supported by radial bearings 104, 114. A hub 106 is supported with a magnetic lift system 112, which contributes to reducing parasitic losses in system 100 during operation. System 100 includes motor/generator 108 for driving the flywheel and generating electrical power from the flywheel during operation.

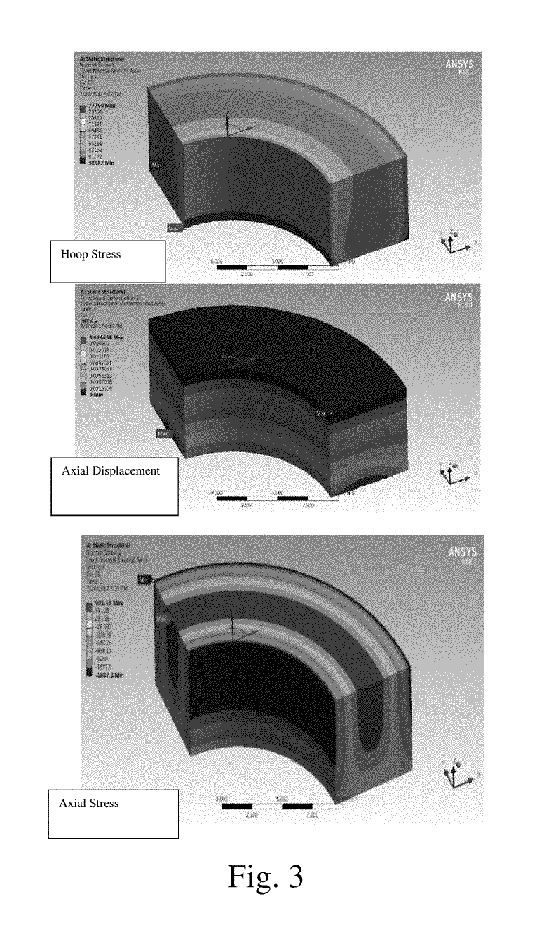

The flywheel in system 100 was modeled and analyzed using finite element analysis (FEA) tools. The flywheel parameters used for the model were: rotational velocity of 16,000 rpm; rim inner diameter of 46 cm (18 in); rim heigh of 46 cm (18 in); rim thickness of 18 cm (7 in); length of 152 cm (60 in); and rim volume of 540 liters (32960 cu in) with a mass of 876 kg (1931 lbs). The analysis of the models is shown in FIGS. 2 and 3.

FIG. 2 is several example partial cross-sectional finite element analysis (FEA) diagrams of radial displacement and radial stress for rim 110 running at 16,000 rpm. The radial displacement diagram shows that the higher displacements occur near the outer edge of rim 110. For example, a maximum displacement of 10.4 mm (0.41 in) is observed at the maximum radius of rim 110. Radial stress is higher at a mid-radial area as shown in the radial stress FEA diagram in FIG. 2. For example, radial stress may reach approximately 40969 kPa (5942 psi) near a mid-radial area of rim 110.

FIG. 3 is several example partial cross-sectional FEA diagrams of hoop stress, axial displacement and axial stress for rim 110 running at 16,000 rpm. The hoop stress in this example is approximately 536343 kPa (77,790 psi), which results from radial displacement, as discussed above regarding FIG. 2. The axial displacement in this example reaches approximately 0.4318 mm (0.017 in) at a maximum. The axial stress reaches approximately 6212 kPa (901 psi) at a maximum.

Current commercial fabrication techniques for rim 110 utilize a unidirectional filament winding manufacturing process, which creates a laminate with carbon fibers and glass fibers oriented in the hoop or circumferential direction. The tensile strength of the fibers is about 4900 MPa (711 ksi). The fiber orientation in the circumferential direction means that the carbon & glass fiber/epoxy laminate reacts the radial force through thickness as an out-of-plane load or stated another way, a normal/transverse load to the laminate. During operation, the radial force is observed as a load through the laminate thickness. The epoxy resin and transverse strength of the unidirectional carbon fiber filaments reacts the radial force during operation. Epoxy neat resin tensile strength is approximately half of the fiber tensile strength, or about 2758 MPa (400 ksi). In actual practice neat resin tensile strength properties are typically greater than inter-lamina resin tensile strengths. Since inter-lamina tensile properties can vary depending upon the resin, volume fraction, fabric type/material, fiber sizing and manufacturing (curing/post curing) method, the actual properties of the composite are empirically determined with coupon testing. The failure mode of rims constructed with this technique is often rim delamination due to radial stress. The radial loading on such rim designs is reacted via the lower strength laminate direction. The practical consequence of the failure mode and construction technique is a significant reduction and upper limit in rotational velocity. Although such composite construction techniques can be modified to bolster inter-laminar strength, the design is still limited with regard to flywheel rotational velocities. In addition, these rim designs obtain a high radial growth during operation, which creates a mismatch between the composite rim and metallic hub on which the rim is mounted.

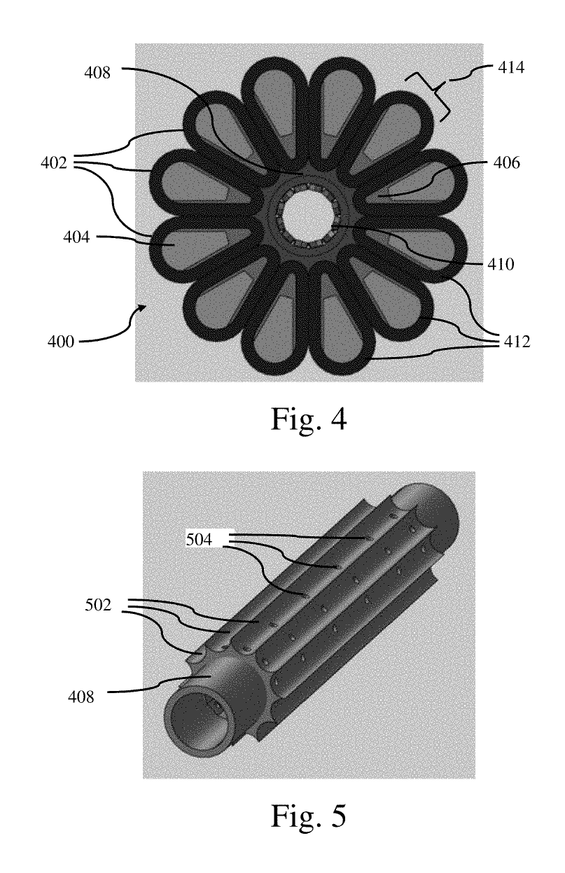

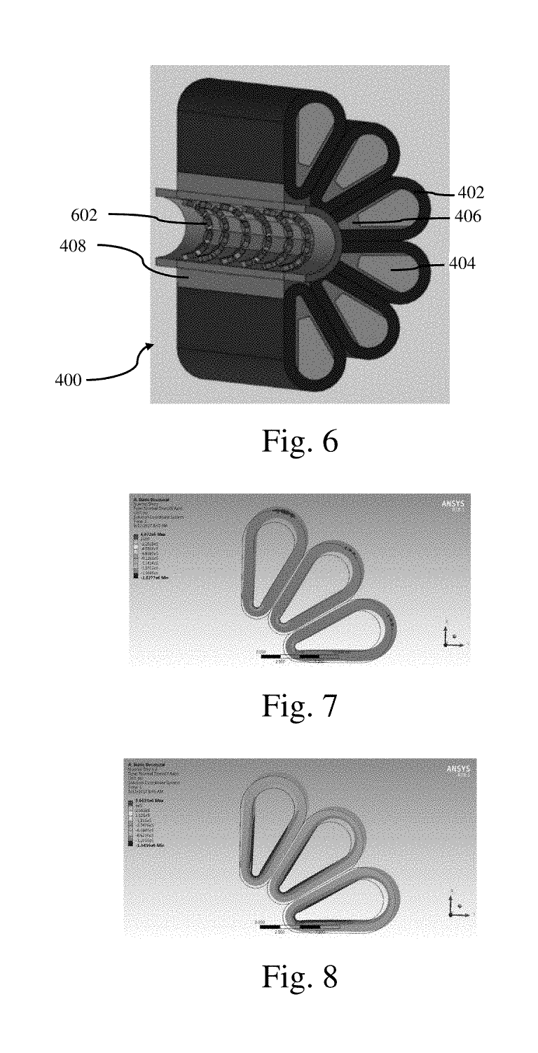

Referring to FIGS. 4, 5 and 6, an example flywheel 400 is illustrated. FIG. 4 is a cross-sectional side view of a flywheel 400 according to an example design of the present disclosure. FIG. 5 is an isometric view of a flywheel sprocket or hub 408. FIG. 6 is a cut away isometric side view of a portion of flywheel 400 showing attachment features.

Flywheel 400 includes twelve lobes 402 that have a wedge-shaped cross section as depicted in FIG. 4. Each of lobes 402 extend the length of flywheel 400, and include an outer casing 412 that is composed of composite materials such as carbon fibers and/or glass fibers in a resin matrix, such as epoxy. Table 1 lists the properties of a carbon/epoxy composite material.

TABLE 1
Carbon/Epoxy Material Properties

| | |
|---|---|
| Ex (Radial) | 1.58E+06 |
| Ey (Hoop) | 2.38E+07 |
| Ez (Axial) | 1.83E+06 |
| nu xy (R/H) | 0.016 |
| nu yz (H/A) | 0.239 |
| nu xz (R/A) | 0.406 |
| Gxy (R/H) | 5.82E+04 |
| Gyz (H/A) | 8.76E+05 |
| Gxz (R/A) | 6.55E+05 |

The fibers are, for example, wound around a hoop direction for each lobe 402 to form casing 412. For example, the fibers are aligned in a circumferential direction with respect to an individual lobe 402 in layers to form a composite laminate. The orientation of fibers can vary between the different lobes 402, e.g. between about 0 and 45 degrees with respect to a normal to a longitudinal axis of lobe 402. Each lobe 402 includes a filler material 404, which may be implemented as a variable density filler. For example, filler material 404 may have a density gradient that increases with radial distance from a center of flywheel 400. Material 404 may have different density material stacked inside each lobe 402. Each lobe 402 may house and retain material 404 against radial loading during operation.

A retaining structure 406 is located internally to each lobe 402. Structure 406 may be metallic, and may be constructed to be a bolt flange that can accept, house or fix fasteners for attaching lobe 402 to hub 408. Lobes 402 can be assembled to or disassembled from hub 408 using a fastener arrangement in conjunction with structure 406. The example flywheel 400 shown in FIG. 4 has bolts 410 that are located in and pass through openings 504 in hub 408 and thread into structure 406 to fasten and secure lobes 402 to hub 408. In such an example, structure 406 provides a threaded opening to receive bolts 410. Other example attachment arrangements include bolts 602 (FIG. 6) that pass through openings 504 and are threaded into nuts (not shown) that are retained in structure 406. The bolts/nuts may, in some examples, be retained inside hub 408 or in structure 406, for example by welds or recesses size and shaped to receive the bolt heads/nuts. Structure 406 may be configured to receive shear pins or shear webs (not shown) that fasten lobes 402 to rods (not shown) that extend through openings 504 from hub 408 into structure 406.

FIG. 5 shows hub 408 with curved recesses 502 that are shaped and sized to be complementary with a smaller dimension end of wedge-shaped lobes 402. Lobes 402 are snugly received in recesses 502 to permit lobes 402 to be tightly secured to hub 408.

In practice, hub 408 is mounted to an axle or rotor supported by radial bearings, such as is illustrated in flywheel system 100 in FIG. 1. Hub 408 may be suspended by a magnetic lift system 112.

The flywheel designs discussed herein seek to improve energy storage, improve reliability and usability and obtain advantages that are unavailable with prior designs. The design example illustrated in FIGS. 4, 5 and 6 can achieve a number of advantages over prior flywheel designs and systems, as discussed below.

The kinetic energy (KE) of a flywheel is given by the following equation (1):

KE=0.5*Iₘ(spin axis)*ω²(in-lbf) (1)

where Iₘ is the mass moment of inertia of the rim about its spin axis, e.g., Iₘ=I+mr², where m is the mass of the rim and r is the radius, and ω is the rotational (angular) velocity. As rotational velocity increases, the radial (centrifugal) force Fᵣ also increases, as given by equation (2).

Fᵣ=m*ω²*r (2)

Thus, while dense material can store more energy it is also subject to higher radial force and thus fails at lower rotation speeds than low density material. Therefore, tensile strength tends to be the more important practical design criteria than density of material, which is the reason that known commercial flywheel rims are composed of low density, high strength carbon & glass fiber/epoxy laminates. With the flywheel designs discussed herein, flywheel filler mass design can be implemented to increase mass while maintaining flywheel and rim integrity. For example, if flywheel mass is doubled, Iₘ is doubled, which according to equation (1) doubles the KE of the flywheel system.

The total kinetic energy stored (Eₖ) for a given mass (m_{c}), is given by equation (3).

Eₖ=0.5m_{c}r²ω² (3)

Equation (3) shows that stored energy increases four-fold for each doubling of rotational velocity ω, due to the squared term. Accordingly, if a flywheel design can be implemented that permits reliable operation at higher rotational velocities, the energy storage, and energy density can be significantly increased.

Radial and hoop rim stresses, as defined by Roark, are a function of radius, r², and the radial body force (δ). The radial body force is a function of radial centrifugal force divided by rim geometric volume. The radial force is a function of m, r and ω² (refer to the radial (centrifugal) force equation discussed earlier). From Roark's Formulas for Stress & Strain, 8th Edition, the equations from Table 13.5, Eqt:1e, p 697 are reproduced below. These equations are for uniformly distributed radial body force δ acting outward throughout the wall, for a disk only.

$${σ}_{1} = 0$$

$${σ}_{2} = \frac{δ ( 2 + v )}{3 ( a + b )} [ {a}^{2} + ab + {b}^{2} - ( a + b ) ( \frac{1 + 2 v}{2 + v} ) r + \frac{{a}^{2} {b}^{2}}{{r}_{2}} ]$$

$${( {σ}_{2} )}_{max} = \frac{{δ a}^{2}}{3} [ \frac{2 ( 2 + v )}{a + b} + \frac{b}{{a}^{2}} ( 1 - v ) ] at r = b$$

$${σ}_{3} = \frac{δ ( 2 + v )}{3 ( a + b )} [ {a}^{2} + ab + {b}^{2} - ( a + b ) r - \frac{{a}^{2} {b}^{2}}{{r}^{2}} ]$$

$$( Note \text{:} {σ}_{3} = 0 at both r = b and r = a . )$$

$${τ}_{max} = \frac{{( {σ}_{2} )}_{max}}{2} at r = b$$

$$Δ a = \frac{{δ a}^{2}}{3 E} [ 1 - v + \frac{2 ( 2 + v ) {b}^{2}}{a ( a + b )} ] , Δ b = \frac{δ ab}{3 E} [ \frac{b}{a} ( 1 - v ) + \frac{2 a ( 2 + v )}{a + b} ]$$

$${ɛ}_{1} = \frac{- δ av}{E} [ \frac{2 ( {a}^{2} + ab + {b}^{2} )}{3 a ( a + b )} ( 2 + v ) - \frac{r}{a} ( 1 + v ) ]$$

Where δ is radial body force per unit volume, a=outer radius, b=inner radius, σ₁=normal stress in the axial direction, σ₂,=normal stress in the hoop or circumferential direction and σ₃=normal stress in the radial direction, E=the modulus of elasticity, v=Poisson's ratio, Δa and Δb are the changes in the radii of a and b, and radial body forces/unit volume=δ. Symbol ε₁=the unit normal strain in the longitudinal direction.

Using the above equations for calculations, in conjunction with FEA simulations, a number of parametric variations can be studied for optimization. Some such parameters include laminate thickness, laminate mass, lobe configurations including number and geometry of lobes, rim diameters, cost calculations with different configurations to reduce high cost items, e.g, amount of carbon/glass fiber material (T700), complexity and assembly costs, varying fiber angle with respect to radial direction, e.g., 10, 20, 30, 45 degrees, and varying filler mass configuration. The flywheel designs discussed herein adopt criteria for one or more of the above parameters, which may be reviewed in combination, to achieve design goals.

The flywheel design illustrated in FIGS. 4, 5 and 6 align a majority of the composite fiber with the radial force to take advantage of the higher tensile strength of the fibers in reacting the force under load. Lobes 402 are thus able to withstand increased loading by meeting tensile and compressive forces in alignment with the carbon/glass fibers of the composite material. The tensile loading of the fibers in the radial direction relieves the comparatively weaker resin from bearing the load. This increased capacity for loading, while maintaining a lightweight structure provided by the composite laminate construction, permits a number of design and/or operational options for increasing energy density and/or storage capacity. The lobe design permits separation of the rim material from the mass filler material, which obtains several advantages including ease of manufacturing and flexibility in design and implementation of the filler mass, to name a few.

Thus use of the filler mass in separate lobes permits design of compressive forces in the composite loop. The separate masses each react to the applied radial force during operation at a designed rotational velocity to apply a compressive force to the composite loop laminate. For example, at operational rotational velocity, radial stress on an outer end 414 (FIG. 4) of a lobe 402 can urge the laminate layers of casings 412 apart near end 414, ultimately leading to delamination and degradation of the integrity of casings 412. The filler material 404 is specified and designed to apply a compressive force to outer ends 414 of lobes 402 to compress the laminate layers together, even as they experience tensile stress that is reacted well by the fibers in the composite material. The compressive force applied to outer ends 414 of lobes 402 counters the potentially delaminating radial stress on casings 412 to contribute to maintaining the mechanical integrity of casings 412.

The separate filler material mass can thus be designed to provide a separate compressive force to ends 414 of each lobe 402 to counteract the through laminate thickness radial tensile force that otherwise cause delamination in prior commercial composite rims, which do not have such filler material masses. Since each filler material mass is separate, they can be individually designed for compressive force based on material density, radial position and rotational velocity. The filler material mass applies a compressive force to counteract composite laminate thru thickness radial stress. In the absence of such a mass, the rim rotational velocity can be limited, such as to about 16,000 rpm, to avoid delamination of composite laminates with fibers oriented in a circumferential direction.

Thus, the same radial force that causes prior rim designs to fail is utilized to apply a force to act on a separate mass. In some example implementations, the mass is not separate. The radial force acting on the filler material mass in each lobe 402 applies a compressive force to casing 412 at outer ends 414 to counteract the same thru thickness rim radial force that is acting to separate the hoop laminate of casing 412 at outer ends 414.

Approximately 70% of the fibers in casing 412 in lobes 402 are oriented in the radial direction. According to other examples, the percentage of fibers aligned in the radial direction can be in the inclusive range of from about 25% to about 90%. Fibers oriented in the radial direction directly react the radial force such that, e.g., the relatively weaker composite resin bears less load. The remaining 30% of the fibers in casing 412, a majority of which are located at outer ends 414, transition to or are aligned in the circumferential direction, where the radial stress induced in part by the rotational velocity acts to separate the laminate layers.

The resin matrix (epoxy) in the composite material of casing 412, having a relatively weaker tensile strength than the fibers, experiences increased loading as the radial force on the portions of casing 412 that have fibers oriented in the circumferential direction is reacted. The comparatively weak tensile strength resin matrix can fail sooner in these regions, e.g., outer ends 414, than does the relatively stronger tensile strength fibers. The thru thickness radial force is increased at greater radial distances, so that outer ends 414 experience significant radial stress, even as the weaker composite material bears greater loads.

The separate mass or variable density filler, being acted upon by the same radial force counteracts the thru thickness force acting on the radial to circumferential directionally transitioning fibers in casing 412. The mass of filler material 404 acts on the fibers in casing 412 at outer ends 414 by applying a compressive force that counteracts the radial force acting on the weaker resin matrix in composite casing 412. This compressive force contributes to avoiding delamination of casing 412 at outer ends 414.

By specifying a design rotational velocity, the filler mass density can be specified and designed to apply the desired compressive force to prevent delamination at outer ends 414. The lobe design for flywheel 400 thus utilizes the tensile strength of the fibers in the composite material to permit significant increases in rotational velocity, while housing mass that contributes to preventing delamination near a flywheel rim. By permitting a significant increase in rotational velocity, significant increases in stored energy density can be achieved, which reduces kW/hr costs. In the case of utilities or other entities that utilize backup energy storage, the present design make flywheels an affordable option without challenges presented by batteries.

Radial forces may also be used to reduce delamination occurrences at the inner ends of lobes 402. Since the inner ends are anchored to hub 408, the radial forces acting on the filler material 404 tends to urge the inner ends of lobes 402 radially outward. This radial outward force is reacted by the mechanism that fastens lobes 402 to hub 408, such as, for example, bolts 410. The reacted radial force applies a compressive force to inner ends of lobes 402 to contribute to preventing delamination in that area, where the relatively weaker resin matrix of the composite material of casings 412 bears greater loading than where the fibers are radially oriented.

In some example implementations of the flywheel system discussed herein, the lobe design of flywheel 400 is better able to retain filler material with a greater density than was possible with prior designs. The greater density translates to greater energy density in the same amount of space. In some example implementations, the rotational velocity of the flywheel can be significantly increased, leading to a multiple of energy density and storage due to the squared rotational velocity term in the equation for the stored kinetic energy Eₖ. The lobe design has detachable sections that permit a larger overall flywheel system to be constructed, even with practical dimension limitations such as a 66 cm (26 inch) hatch size for naval vessels through which the flywheel system is to be transported. The modular feature of the lobe design offers greater opportunity for maintenance and repair, where a malfunctioning/damaged lobe can be replaced onsite (onboard), while the prior flywheel design would not be replaceable or potentially repairable until the vessel reaches a port with the capacity to provide such services. The lobe design can provide higher density energy storage in a smaller space than prior designs, leading to reduced operational space, reduced cost, potentially greater numbers of flywheel system in a given space, and other such physical advantages. For example, the failure mode of the lobe design due to rim radial stress is implemented such that exceeding matrix tensile strength causes delamination, which is how prior composite rim designs fail. The lobe design can take advantage of low cost extrusion and/or pultrusion fabrication processes, which can be implemented in parallel, to speed manufacture and reduce associated costs.

A number of example implementations for a lobe-design flywheel were tested, with the results compiled in Table 2 below. Each of the example implementations were run at 16,000 rpm and at 36,000 rpm, resulting in the two columns of data for each example.

TABLE 2

| | Known | | | | | | | | |
|---|---|---|---|---|---|---|---|---|---|
| | Rim | Example 1 | | Example 2 | | Example 3 | | Example 4 | |
| Iz = 0.5*m*(OR\hat{ }2 + IR\hat{ }2) | 842.06 | 279.55 | 279.55 | 315.40 | 315.40 | 246.61 | 246.61 | 353.05 | 353.05 |
| (in lb s\hat{ }2) | | | | | | | | | |
| Mass Moment of Inertia | | 83794.22 | 83794.22 | 118136.19 | 118136.19 | 91198.83 | 91198.83 | 144466.72 | 144466.72 |
| Iz - SW (lbm*in\hat{ }2) | | | | | | | | | |
| Iz Calculated vs Iz | | 216.86 | 216.86 | 305.74 | 305.74 | 236.02 | 236.02 | 373.88 | 373.88 |
| SolidWorks Comparison | | | | | | | | | |
| Omega (rpm) | 16000.00 | 16000.00 | 36000.00 | 16000.00 | 36000.00 | 16000.00 | 36000.00 | 16000.00 | 36000.00 |
| Omega (rad/s) | 1675.51 | 1675.51 | 3769.91 | 1675.51 | 3769.91 | 1675.51 | 3769.91 | 1675.51 | 3769.91 |
| KE = ½ Iz omega\hat{ }2 (in lb) | 1.18E+09 | 3.04E+08 | 1.54E+09 | 4.29E+08 | 2.17E+09 | 3.31E+08 | 1.68E+09 | 5.25E+08 | 2.66E+09 |
| 1 J = 8.85 in lb | 8.85 | 8.85 | 8.85 | 8.85 | 8.85 | 8.85 | 8.85 | 8.85 | 8.85 |
| KE (MJ) | 133.56 | 34.40 | 174.13 | 48.49 | 245.49 | 37.43 | 189.51 | 59.30 | 300.21 |

The flywheel designs included rim diameters varying from 61 cm (24 in) to 152 cm (60 in). As can be seen from the data in Table 2, the lobe design flywheel systems were operable at the same or higher (more than 2×) the rotational velocity of the prior flywheel rim designs, and had mass moments of inertia that contributed significantly to a much higher KE.

Referring to FIGS. 7 and 8, partial cross-sectional stress FEA diagrams for several lobes of the flywheel design of FIG. 4 are shown. FIG. 7 is a radial stress FEA diagram, normalized to 17237 kPa (2500 psi). FIG. 8 is a hoop stress FEA diagram, normalized to 4137 MPa (600 ksi). The lobe design modeling and analysis were conducted for 32,000 rpm. In one example analysis, a filler density of 0.00554 kg/cm³ (0.2 lbs/in³) resulted in a mass inertia of 413.8 kg-m² (1,4132,988 lbm-in²) and a kinetic energy up to 236,940,697 kg-N m or 2324 MJ (1,713,794,778 ft-lbf). In another example analysis, a filler density of 0.00277 kg/cm³ (0.1 lbs/in³) resulted in a mass inertia of 279.1 kg-m² (953,705 lbm-in²) and a kinetic energy up to 159,811,371 kg-N m or 1567 MJ (1,155,917,485 ft-lbf).

Tables 3 and 4 provide data for lobe design flywheels for 102 cm (40 in) diameter rim examples and for 61 cm (24 in) diameter rim examples, respectively. The values are compared against prior rim design values.

TABLE 3

| | | Pror Rim | | | |
|---|---|---|---|---|---|
| | | 1 | 2 | 3 | 4 |
| | Prior Rim | Loop XS T = 1.5 | Loop XS T = 1.75 | Loop XS T = 1.5 | Loop XS T = 1.5 |
| | Analysis Results | F = 0.1 Density | F = 0.4 Density | F = 0.1 Density | F = 0.2 Density |
| Rotational Velocity (rpm) | 16,000 | 16,000 | 16,000 | 32,000 | 32,000 |
| Rotational Velocity (rads/sec) | 1,676 | 1,676 | 1,676 | 3,351 | 3,351 |
| Rim Diameter (in) | 32 | 40 | 40 | 40 | 40 |
| Rim Length (in) | 60 | 60 | 60 | 60 | 60 |
| Rim Mass (lb) | 2,224.00 | 4,725.40 | 10,826.31 | 4,725.40 | 6,759.04 |
| Rim Mass Moment of Inertia | 460,670 | 953,705 | 2,334,556 | 953,705 | 1,413,989 |
| (lbm*in2) | | | | | |
| Kinetic Energy (in-lbf) | 1,352,828,883 | 3,467,752,455 | 8,488,648,130 | 13,871,009,821 | 20,565,537,339 |
| 1 Joule = 8.85 in-lb | 8.85 | 8.85 | 8.85 | 8.85 | 8.85 |
| Kinetic Energy (J) | 152,862,021 | 391,836,436 | 959,169,280 | 1,567,345,742 | 2,323,789,530 |
| Kinetic Energy (MJ) | 152.86 | 391.84 | 959.17 | 1567.35 | 2323.79 |

TABLE 4

| | | Pror Rim | | |
|---|---|---|---|---|
| | | 5 | 6 | 7 |
| | Prior Rim | Loop XS T = 0.5 | Loop XS T = 0.5 | Loop XS T = 0.5 |
| | Analysis Results | F = 0.4 Density | F = 0.4 Density | F = 0.4 Density |
| Rotational Velocity (rpm) | 16,000 | 16,000 | 15,000 | 15,000 |
| Rotational Velocity (rads/sec) | 1,676 | 1,676 | 1,571 | 1,571 |
| Rim Diameter (in) | 32 | 24 | 24 | 24 |
| Rim Length (in) | 60 | 60 | 36 | 39.4 |
| Rim Mass (lb) | 2,224.00 | 5,791.29 | 3,474.78 | 3,802.95 |
| Rim Mass Moment of Inertia | 460,670 | 421,792 | 253,075 | 276,976 |
| (lbm*in2) | | | | |
| Kinetic Energy (in-lbf) | 1,352,828,883 | 1,533,670,633 | 808,771,636 | 885,155,608 |
| 1 Joule = 8.85 in-lb | 8.85 | 8.85 | 8.85 | 8.85 |
| Kinetic Energy (J) | 152,862,021 | 173,296,117 | 91,386,626 | 100,017,583 |
| Kinetic Energy (MJ) | 152.86 | 173.3 | 91.39 | 100.02 |

Examples 1-4 in Table 3 use a flywheel rim diameter of 102 cm (40 in), a flywheel length of 152 cm (60 in) and vary the filler density F=2.768, 11.07, 5.536 g/cm³ (F=0.1, 0.4, 0.2 lbs/in³) and rotational velocity (16 k and 32 k rpm). For a filler density of 11.07 g/cm³ (0.4 lbs/in³), the carbon fiber loop wall thickness was increased from a thickness of 3.81 cm (1.5 in) to 4.45 cm (1.75 in) to reduce carbon fiber tensile stress to acceptable levels ˜4137 MPa (˜600 ksi). For the densities in examples 5 through 7 in Table 4, loop wall thicknesses were held constant at 3.81 cm (1.5 in). The rim analyses was conducted by resolving radial, hoop and axial stress at 16,000 rpm for the lobe design for a direct comparison to the prior rim design, for which well-established data is available. This direct comparison is shown for the 102 cm (40 in) rim implementation in example 1 in Table 3, where the kinetic energy, based on a mass of 2143 kg (4725 lbs), provides 392 MJ.

Comparing results for examples 1 and 2 that use a rotational velocity=16,000 rpm with example 3 that uses a rotational velocity=32,000 rpm, significant increases in kinetic energy, e.g., several orders of magnitude over example 1, are observed. Comparing examples 1 and 2 that have the same rotational velocity=16,000 rpm, the ability of the lobe design to utilize mass to significantly increase flywheel kinetic energy, with all other variables such as geometry and/or stress being held constant, becomes evident. By increasing loop filler mass from a pultruded glass—epoxy filler laminate with a density of 2.768 g/cm³ (0.1 lbs/in³) to lead with a density of 11.07 g/cm³ (0.4 lbs/in³) linearly increases flywheel kinetic energy from 392 MJ to 959 MJ.

Comparing example 1 to 3, with all variables held geometrically constant except rotational velocity, which was increased from 16,000 rpm to 32,000 rpm, significant changes are observed. The contribution of rotational velocity to kinetic energy is squared, rather than a linear increase as with mass. Accordingly, flywheel kinetic energy approximately quadruples from 392 MJ at 16,000 rpm to 1,567 MJ at 32,000 rpm

Referring to Table 3, example 4, the filler mass density is increased from 2.768 g/cm³ (0.1 lbs/in³) (example 1) to 5.536 g/cm³ (0.2 lbs/in³). This mass density increase imposes a carbon fiber tensile stress of ˜4137 MPa (˜600 ksi) at a rotational velocity of 32,000 rpm with a loop wall carbon fiber thickness of 3.81 cm (1.5 in). Example 4 thus seeks to maximize tensile stress imposed on the carbon fiber as a useful tool to validate the loop design. As shown in Table 3, there is an almost 50% increase in flywheel kinetic energy from 1,567 MJ to 2,324 MJ.

Examples 1-4 in Table 3 thus highlight the significant potential of the new flywheel rim design, which permits the use of mass, geometry and rotational velocity to enhance total energy stored in a flywheel energy system (FES) while maintaining design constraints on performance and/or volumetric space. The examples also illustrate the potential for standardizing filler material to permit low cost pultrusion manufacturing techniques to be employed to construct the flywheel components. An advantage offered by such standardization is less variation in filler mass fabricated densities, which can contribute to simplifying flywheel balancing.

If a direct “black box” replacement solution for current flywheel designs is desired, examples 5-7 in Table 4 can be employed. Examples 5-7 use rim diameters of 61 cm (24 in), and filler densities of 11.07 g/cm³ (0.4 lbs/in³), which can replace prior flywheels with a form factor that uses a 81.3 cm (32 in) diameter and significantly less rim density. The 61 cm (24 in) diameter form factor is particularly appealing for vessels with a hatch limitation of 66 cm (26 in), where the new flywheel design can be directly loaded into a vessel to replace prior flywheel implementations without loss of performance specifications. In some example implementations of the new designs, the dimensions of the rim components, e.g., lobes, are 36 cm (14 in) in length by 22 cm (8.5 in) in width by 152 cm (60 in) in length, and weigh 76.11 kg (167.76 lbs) per lobe.

Also notable is the reduced rotational velocity in examples 6 and 7 in Table 4 of 15,000 rpm compared with the prior flywheel design. A design consideration for the flywheel system is any other component limitations on rotational velocity, torque or other parameters. For example, some motor/generator designs may have a desired range of operation at a certain rotational velocity range, leading to selection of flywheel parameters to enhance overall operation of the combination of flywheel components.

In Tables 3 and 4, the prior rim radial stress rated maximum is 40.97 MPa (5942 psi). The radial stress modeled for each of the above seven examples in Tables 3 and 4 is less than the prior rim design, showing that the new designs are capable of meeting prior specifications. As can be seen from the data in Tables 3 and 4, the flywheels according to the new design were able to have significantly increased mass moments of inertia, and attendant kinetic energy. The boosts to kinetic energy were most significant with increases in rotational velocity. A significant increase in kinetic energy was observed in Example 5, where the rim diameter was small than prior flywheel systems, but the filler density was able to be increased due to the implementation of the lobe design.

Examples 5, 6 and 7 in Table 4 illustrate the increase in energy density possible with the new design that permits the prior flywheel systems to be directly replaced with lobe design flywheel systems. The form factor of a 24 inch diameter permits the lobe design flywheel system to be received in a vessel with the constraint of a 26 inch diameter hatch. Because the lobe design is modular, the 40 inch diameter flywheel systems may also be received in a vessel with the hatch dimension constraints, as the component parts meet the physical constraint, and may be assembled inside the vessel.

As seen in Examples 6 and 7 in Table 4, the length of the rim can be reduced while still providing significant kinetic energy. This physical size reduction permits more units to be used in less space to increase the energy density of the collective flywheel systems. The number of flywheel systems may be reduced compared with prior flywheel designs, reducing upfront purchase costs, maintenance costs, and reduce use of valuable space onboard vessels.

The flywheel rim designs discussed herein may be used with current flywheel components, such as motor/generators, radial bearings, magnetic lift systems, so that cost can be reduced for implementation of the new designs. Such reuse of current flywheel components implies example design specifications that include: a maximum rotational velocity of 15, 000 rpm, 3 MW average power, 4.5 MW peak power, 25 MJ energy storage, and total system capability of 12 MW.

Filler material 404 can be any type of material that fulfills design specifications. Two attractive materials are aluminum and steel. Aluminum is useful as a filler material because of its relatively light weight for its rigidity. Steel represents a greater mass material also with rigidity properties that are useful in flywheel applications.

Another design variable is loop wall thickness, for example the thickness of casing 412. For 61 cm (24 in) diameter rims, thinner wall thicknesses, such as 0.635 cm (0.25 in), in loops operating at 32 k rpm produced a loop displacement of 0.681 cm (0.268 in) and a fiber tensile stress of 1514 MPa (219550 psi) at outer end 414, which values are in an undesirable range as limiting higher rotational velocities. As wall thickness increases, other parameter influences become dominant. For example, a wall thickness of 1.91 cm (0.75 in) reduces the volume of aluminum filler material at 32 k rpm to the point where there is not enough mass to offset increasing radial stress (12.85 MPa (1864 psi)) to casing 412. The use of steel filler increases the filler mass and in turn the radial stress to beyond desired operating ranges. In addition, the use of the denser steel filler resulted in a mass that significantly increased magnetic bearing parasitic losses. To permit flexibility in all design parameters, such as dimensions, rotational velocity, and filler density to name a few, the wall thickness is located at 1.59 cm (0.625 in), and may be varied depending on the application and other design parameters. For example, larger diameter rims, such as 152 cm (60 in) may use loops with a wall thickness of 3.175 cm (1.25 in) to meet the greater applied stresses.

The number of loops or lobes may be varied. For example, reducing the number of lobes reduces the amount of expensive fiber in the composite material used to construct the lobes, leading to overall cost savings. A reduction in the number of components can also reduce manufacturing and maintenance costs. Studies reviewing the number of loops at 4, 6, 8, 10 and 12 loops indicate that loop displacement and/or radial/hoop stresses are not significantly adversely affected by lessening the number of loops. As the number of loops decreases, the loop area subject to radial force increases for fixed diameter rims. As loop area increases, the filler material mass increases, assuming the same material is used. As less of the rim is composed of lightweight composite material with the decrease in number of loops, the overall mass of the rim increases due to the greater cross sectional area of the loop containing filler material. The increase in filler material mass tends to increase magnetic bearing parasitic losses.

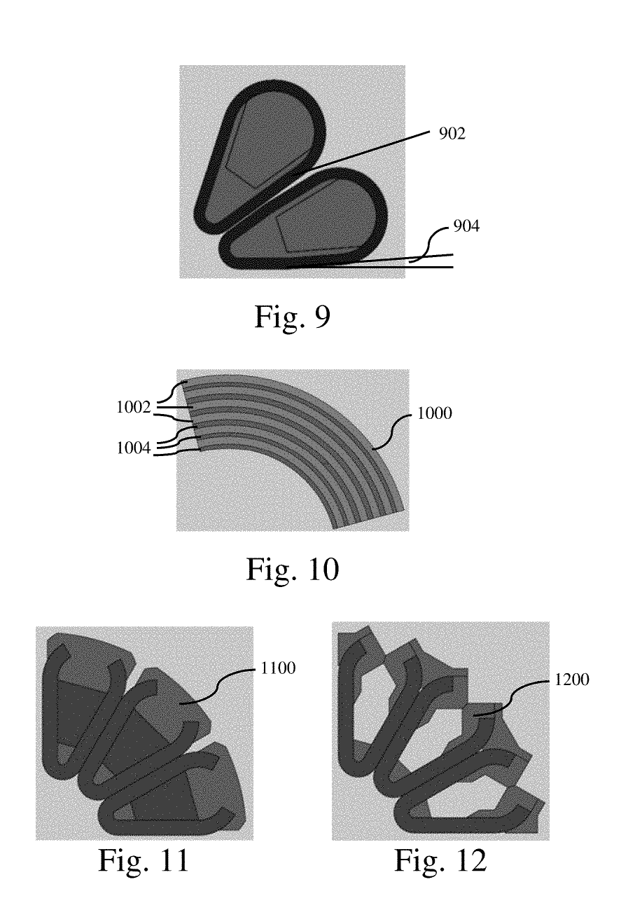

The loop area subject to radial force may be modified or designed to meet specific criteria, including controlling magnetic bearing parasitic losses. For example, the loop area subject to radial force, as well as the volume of the filler mass, may be reduced by modifying loop cross section dimensions along the length of the radially aligned portions of the loop. FIG. 9 illustrates such a cross section dimension modification in an example using 10 loops to construct a rim. A loop beam 902 extends in the radial direction, and has an angular modification at an angle 904 in the outer radial region that serves to reduce loop cross sectional area, thereby controlling filler material volume and mass. These modifications can be applied to any of the loop/lobe designs discussed herein, for any number of loops/lobes.

According to some example implementations, the lobes (loops) attached to a hub may be spaced from each other, such that a gap is provided between each lobe. In such examples, the lobes may/may not be provided with lateral support, for example by the presence or absence of circumferentially aligned support members between the lobes. In some examples, the lobes may be provided with a freedom of movement in a circumferential direction, such as by, for example, being permitted to pivot with respect to the hub. In some examples, a filler material or structure may be provided between the lobes, which can contribute to maintaining the position of lobes with respect to each other. The variations or modifications to the lobes and their arrangements can be applied to any of the various examples discussed herein.

The filler mass composition and disposition can be utilized as a design parameter. For example, the filler material can be any type of useful material including metallic, fiber/matrix composite, polymer or plastic/thermoplastic or combinations thereof, as non-limiting examples. The filler material may be constructed by molding, including injection molding, machining, stamping, 3-D printing and/or other operations that can reduce costs and/or improve quality.

FIG. 10 is a partial cross-sectional side view of a flywheel rim 1000, designed with loops around the circumference of the rim. Segmented quarter circle aluminum rim inserts 1004 are nested between carbon/epoxy rims 1002. Inserts 1004 are masses that apply a compressive force to rims 1002, which tends to balance a radial stress experienced by rims 1002. The design of rim 1000 can control delamination stresses with the alternating layers of inserts 1004 and rims 102.

FIGS. 11 and 12 provide alternate lobe designs that align mass with radial aligned carbon fiber/epoxy laminates. Rims 1100 and 1200 have aluminum end caps that are bolted assemblies which, once assembled, geometrically lock the mass structure to the carbon/epoxy beam. Rim 1100 utilizes the volume between the radial beams to house filler material. Rim 1200 aligns the mass of the aluminum end caps directly along the center line of the beams. The designs of rims 1100 and 1200 exploit the alignment of fiber tensile strength in the radial direction. Radial stress is observed in the outer radial areas of the composite beams near the end curvature. This radial stress is a thru thickness tensile stress, which can be controlled with bolt tension applying a compressive force to the beam end curvature. Bolt torque would be dependent on designed rotational velocity.

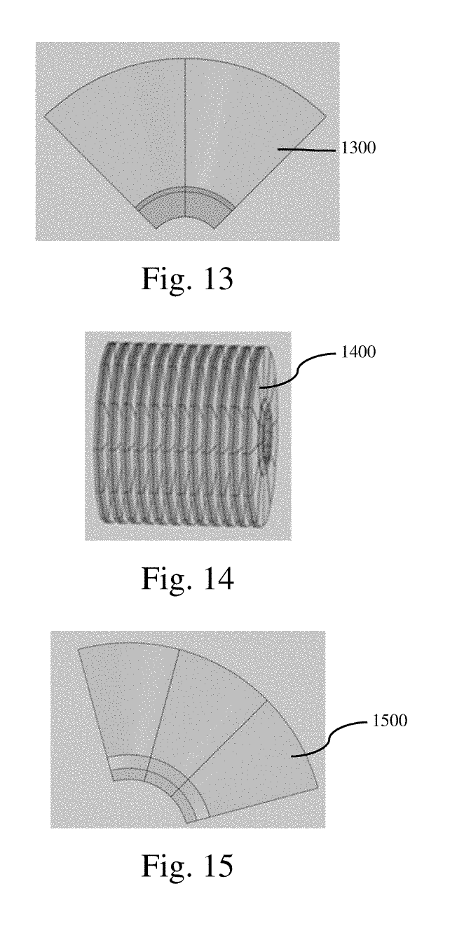

FIGS. 13, 14 and 15 illustrate an annular rim design with fiber orientation in the radial direction to restrict rim radial growth to reduce hoop aligned fiber radial stress. This design permits a variety of geometrical options that can be employed to reduce radial and/or hoop stress. In rims 1300, 1400 and 1500, radial stress is applied to the radially aligned fibers in the hoop direction. An alternate name for this stress is radially aligned fiber hoop matrix stress or hoop resin stress. The radial fiber alignment in rims 1300, 1400 and 1500 is different from prior rim designs, which orient fibers in the hoop direction. In such prior designs the radial stress acts through the rim thickness in the radial direction, loading the tensile strength of the resin rather than the fiber in the rim composite material. Rims 1300, 1400 and 1500 have significantly reduced radial stress at operational rotational velocity, e.g., on the order of 20.97 MPa (3041 psi).

Other benefits are available with the annular rim design illustrated with rims 1300, 1400 and 1500. For example, the annular rims are torqued onto a central shaft, permitting control of fixation to the central shaft. The number of annular rims mounted on the shaft can be varied to determine FES energy stowage capability. A number of parameters for the annular rims can be varied according to design goals, including annular rim thickness, geometric cross section, rotational velocity, radius and filler mass. The annular rim design is modular and permits failing annular rims to be removed on site. New annular rims can be installed to replace the failing ones, or the axle can be reassembled with fewer rims and returned to operational status. Annular rims can be designed with varying mass, and selected for use to achieve desired operating parameters, such as energy stowage or rotational velocity. The component count for the annular rim design may also be reduced, leading to reduced costs and simplified maintenance. Since the annular rim design is modular, larger overall rims can be constructed despite physical transport limitations such as a 66 cm (26 in) hatch size in a vessel in which the flywheel is to be deployed.

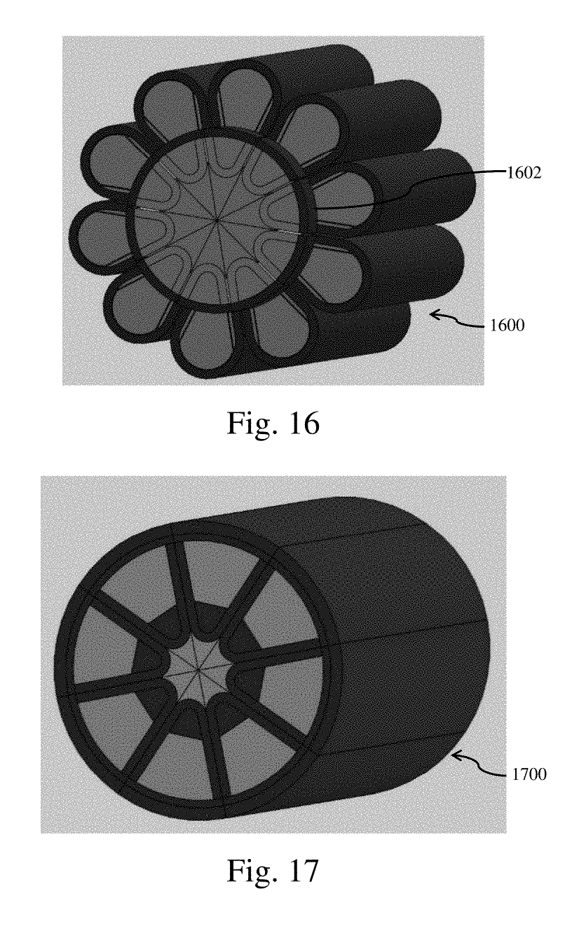

FIG. 16 is a partial isometric view of a 10 lobe flywheel rim 1600 with a full length sprocket hub. The sprocket hub interacts with each loop inner axle extension component to react motor/generator torque stresses. Rim 1600 includes a hub hoop band 1602 that can contribute to relieving inner axle stress.

FIG. 17 is an isometric view of an eight lobe flywheel rim 1700 with a solid aluminum filler material. Rim 1700 includes end hubs combined with a central sprocket hub. Rim 1700 uses a central sprocket hub in conjunction with end hubs to react both loop bending and cyclic motor/generator acceleration/deceleration (torque) stresses. The end hub is milled to fit over the ends of the central sprocket hub and welded in place. With the design of rim 1700, the radial deformation is excellent as it reduces metallic component flexure stress, hub reaction stresses and reduces laminate cyclic fatigue over the operational life of the rim. The design of rim 1700 uses a “semi-loop” geometry concept, where the rim is divided into 8 “loop-like” sections that are bonded together and this sub-assembly then undergoes exterior hoop carbon fiber filament winding. Filament winding binds the “loop-like” sections into a unified rim structure. This construction results in comparatively low stresses on the central sprocket hub. This design extends the central sprocket hub full length and utilizes end hub integration to effectively react flexure. The design controls axial deflection well, which reduces component/assembly stress, a target for reducing the impact of cyclic fatigue. Although the component count of this design may be considered high, the components have simple 2D geometric cross sections permitting low-cost fabrication by extrusion or pultrusion. The concepts shown for rim 1700 end hub and central sprocket hub joint components are readily transferable to other rim implementations and can hub stresses. Rim 1700 may be implemented with an axially oriented carbon fiber-epoxy composite inner axle component.

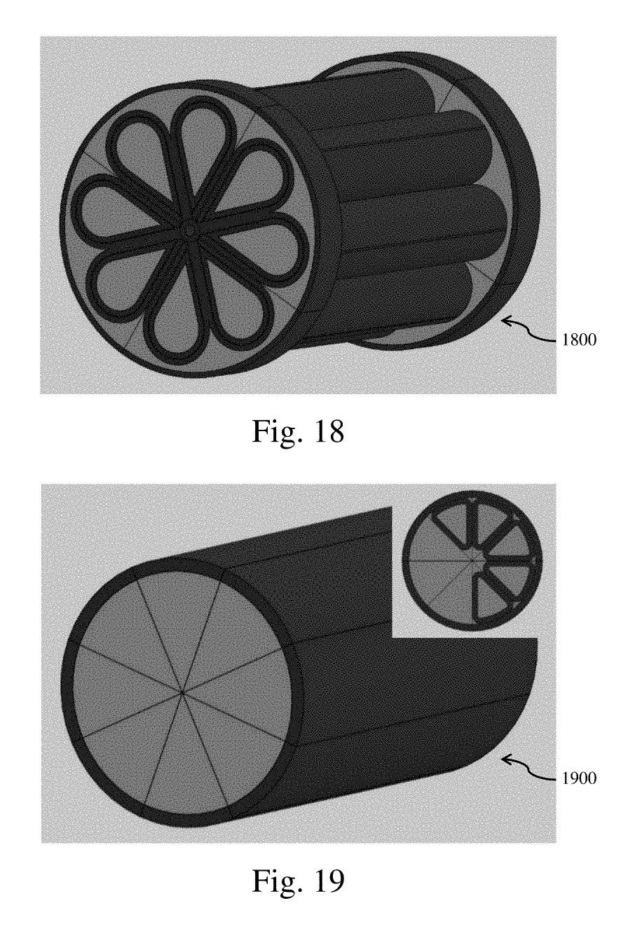

FIG. 18 is an isometric view of an eight lobe flywheel rim 1800 that utilizes the loop geometry to integrate the loop into a central hub-like structure. Rim 1800 can orient 4-90 degree double loop structures around a central hub axis, similar to a hinge, or each of the 4-90 degree double loop structures can form their own respective hubs, such that the central hub becomes an assemblage of the 4-90 degree double loop structure hubs. The design of rim 1800 permits the carbon-epoxy laminate to deform somewhat independently of the aluminum filler components, which reduces aluminum material stresses. This design builds elasticity into the carbon-epoxy material system.

This design permits the offsetting of filler rim mass to either side of the radially aligned carbon-epoxy fibers. In other examples discussed herein, the load bearing carbon fiber is directed around the filler mass, resulting in transfer of the carbon fiber load to the metallic components. In the design of rim 1800, increases in the radial load are directly reacted by the radially aligned carbon fiber. The filler masses are positioned to either side of this load bearing radially aligned fiber which is out of the load path, thus reducing metallic component stress. This design offers a low component count and simplified geometric load path, which is important from a stress perspective.

FIG. 19 is an isometric view of an eight lobe flywheel rim 1900 utilizes end hubs. This design seeks to improve the loop/end hub concept, reduce component counts and investigate alternate end hub configurations. Rim 1900 can utilize axially and/or hoop oriented fibers to control loop axial deformation and loop cross sectional deformation. The loop axial deflection that increases with increasing rotational velocity can be reacted by using both axial and hoop oriented fibers. Accordingly, rim 1900 can achieve reduced deflection while offering a low component count, the ability to design each component for a given rotational velocity and elimination of milling and assembly costs of a sprocket hub. The aluminum end hub and filler designs permit low cost extrusion and the axial oriented fiber around the aluminum filler can utilize low cost pultrusion manufacturing. The hoop fibers utilize a filament winding process for the sub-assembly.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known processes, structures, and techniques have been shown without unnecessary detail to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional stages or functions not included in the figure.

Having described several example configurations, various modifications, alternative constructions, and equivalents may be used without departing from the spirit of the disclosure. For example, the above elements may be components of a larger system, wherein other structures or processes may take precedence over or otherwise modify the application of the invention. Also, a number of operations may be undertaken before, during, or after the above elements are considered. Accordingly, the above description does not bound the scope of the claims.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

What is claimed is:

1. A flywheel for a flywheel energy storage system, comprising:
a hub configured to rotate about a longitudinal axis;
a fiber-resin composite material coupled to an outer side of the hub; and
at least some of the fibers in the composite material being radially aligned with respect to the longitudinal axis.

2. The flywheel of claim 1, further comprising a disc section composed of the fiber-resin composite material coupled to the hub.

3. The flywheel of claim 1, further comprising a loop composed of the fiber-resin composite material coupled to the hub.

4. The flywheel of claim 3, further comprising a mass housed within the loop such that the mass can apply compressive force to the loop when a radial force is applied to the mass.

5. The flywheel of claim 4, wherein the mass is one or more of aluminum or steel.

6. The flywheel of claim 3, wherein a percentage of fibers aligned in the radial direction are in an inclusive range of from about 25% to about 90%.

7. The flywheel of claim 3, further comprising four or more loops arranged symmetrically around the hub.

8. The flywheel of claim 3, further comprising a fastener to affixedly couple the loop to the hub.

9. The flywheel of claim 8, wherein the fastener further comprises one or more of a bolt, a nut, a threaded opening in the loop, or a rod and shear pin or shear web.

10. The flywheel of claim 1, wherein the hub and a fiber-resin composite material are configured to withstand a rotational velocity in an inclusive range of from about 15,000 rpm to about 50,000 rpm.

11. The flywheel of claim 1, wherein the rim diameter is in an inclusive range of from about 45.7 cm (18 in) to about 203 cm (80 in).

12. The flywheel of claim 1, wherein the flywheel is configured to obtain a kinetic energy in an inclusive range of from about 10 MJ to about 3000 MJ.

13. The flywheel of claim 1, wherein the fiber-resin composite material is releasably coupled to the outer side of the hub, such that the flywheel is modular in construction.

14. A method for constructing a flywheel for a flywheel energy storage system, comprising:
coupling a fiber-resin composite material to an outer side of a hub configured to rotate about a longitudinal axis; and
aligning at least some of the fibers in the composite material in a radial direction with respect to the longitudinal axis.

15. The method of claim 14, further comprising arranging the fiber-resin composite material in a loop.

16. The method of claim 15, further comprising disposing a mass within the loop such that the mass can apply compressive force to the loop when a radial force is applied to the mass.

17. The method of claim 15, further comprising disposing four or more loops symmetrically around the hub.

18. The method of claim 15, further comprising fastening the loop to the hub with one or more of a bolt, a nut, a threaded opening in the loop, or a rod and shear pin or shear web.

19. The method of claim 14, further comprising implementing a rim diameter in an inclusive range of from about 76.2 cm (30 in) to about 203 cm (80 in).

20. A method for operating a flywheel for a flywheel energy storage system, comprising operating the flywheel at a rotational velocity in an inclusive range of from greater than 16,000 rpm to about 50,000 rpm.

21. The method of claim 20, further comprising operating the flywheel to obtain a kinetic energy in an inclusive range of from about 200 MJ to about 3000 MJ.
